(19) United States
(12) Patent Application Publication
(10) Pub. No.: US 2025/0328360 A1
(43) Pub. Date: Oct. 23, 2025

(54) USER INTERFACE COMPONENT CONFIGURATION FOR REQUESTS ASSOCIATED WITH ITEMS

(71) Applicant: Dell Products L.P., Round Rock, TX (US)

(72) Inventors: Sisir Samanta, Austin, TX (US); Shibi Panikkar, Bangalore (IN)

(21) Appl. No.: 18/639,259

(22) Filed: Apr. 18, 2024

(51) Int. Cl. G06F 9/451

(52) U.S. Cl. CPC G06F 9/451

(57) ABSTRACT

Methods, apparatus, and processor-readable storage media for configuring user interface components for requests associated with items are provided herein. An example computer-implemented method includes determining a context of a request associated with an item, where the context is determined based on: at least one action, from among a plurality of actions, associated with the item, and at least one state, from among a plurality of states, associated with the item. The method includes obtaining a template for the request based at least in part on the determined context, where the template specifies a functionality of at least one user interface element based at least in part on the determined context. The method also includes generating a component for a user interface of a device associated with the request using the template, where the user interface controls the functionality of the at least one user interface element based on the component.

### BACKGROUND

Organizations are increasingly providing complex and configurable technologies, including as-a-service technologies. For example, a given organization may provide hardware and/or software resources to one or more users at different geographical locations.

### SUMMARY

Illustrative embodiments of the disclosure provide techniques for configuring user interface components for requests associated with items. An exemplary computer-implemented method includes determining a context of a request associated with at least one item, wherein the context is determined based at least in part on: (i) at least one action, from among a plurality of actions, associated with the at least one item, and (ii) at least one state, from among a plurality of states, associated with the at least one item. The method includes obtaining a template for the request based at least in part on the determined context, wherein the template specifies a functionality of at least one user interface element based at least in part on the determined context. The method also includes generating a component for a user interface of a device associated with the request using the template, wherein the user interface controls the functionality of the at least one user interface element based on the component.

Illustrative embodiments can provide significant advantages relative to conventional techniques. For example, technical problems associated with loading and rendering times of user interfaces related to configurable items are mitigated in one or more embodiments, at least in part, by dynamically generating a user interface component using context-based templates. In some embodiments, the user interface component can restrict or allow adjustment of certain features based on a current context of the configurable item. These and other embodiments can effectively reduce the size and complexity of configuration components, thereby improving loading and rendering times of the user interface relative to conventional techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for configuring user interface components for requests associated with items in an illustrative embodiment.

FIG. 2 shows an example of an architecture for configuring a user interface in an illustrative embodiment.

FIG. 3 shows a flow diagram for generating template data structures in an illustrative embodiment.

FIG. 4 shows an example of a template data structure in an illustrative embodiment.

FIGS. 5 through 7 show examples of a user interface configured at different states in illustrative embodiments.

FIG. 8 shows a flow diagram of a process for configuring user interface components for requests associated with items in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Generally, a service provider refers to an entity (e.g., an organization) that provides hardware and/or software resources utilized by one or more service consumers (e.g., one or more users, possibly associated with one or more organizations different than the service provider organization). For instance, a given service consumer can request resources based on current and/or projected resource demands. A resource configuration can be created to fulfill the request. In some embodiments, this resource configuration can comprise various parameters such as billing parameters (e.g., values, rates, billing periods, type of currency, etc.), one or more types of resources, a number or size of one or more resources, etc.

For example, a user can configure a request (e.g., via a user interface) for a service and/or a product by selecting values for one or more attributes of the requested service. As an example, for a storage service, the attributes may include a service attribute indicating how the storage service is provided (e.g., on a subscription or perpetual basis), a type attribute indicating a storage technology for the storage service (e.g., a cloud storage technology, a hybrid cloud storage technology, and/or a local storage technology), a performance attribute (e.g., a size or speed of the storage service), a term attribute (e.g., in months or years), and possibly one or more add-on attributes related to optional features for the storage service (e.g., a customer support plan, an auto-renewal option, etc.).

Many technical challenges exist in initiating and managing configurations of user requests in a self-service manner while hiding the internal complexities involved in such requests and supporting internal operations. This is partially due to the number, complexity, and/or customizability of available options for these resource requests. It is often desirable for configuration interfaces to not only support actions related to an initial request for obtaining products and/or services (referred to as “Day-1 actions”), but also subsequent configuration or customization of the product and/or service (referred to as “Day-2 actions”). Day-2 actions pose unique challenges as the actions are often dependent on the current state of the configuration and the options should be tailored accordingly.

The term “dynamic request” as used herein is intended to be broadly construed so as to encompass, for example, a request related to acquiring one or more products and/or one or more services (for example, as-a-service technologies), as well as requests associated with one or more subscriptions or other ongoing, recurring and/or reoccurring requests. The term “configurable item” as used in herein is intended to be broadly construed so as to encompass, for example, a data structure comprising information related to one or more dynamic requests. A configurable item can include data associated with one or more products and/or one or more services (potentially across multiple applications), where the data is created and/or modified in response to one or more dynamic requests.

Existing techniques for processing dynamic requests typically involve creating separate software configuration components for each type of product and/or service, which may require extensive development work and increased resources due to individual maintenance and execution of these components. An alternate approach employs a single configuration component with customization of the underlying logic for specific requests. However, this alternate approach involves increased development effort to manage service-specific logic and/or product-specific logic. Additionally, a single configuration component can adversely impact user experience by increasing the size and/or complexity of the component during run time, resulting in slower loading and/or rendering of the component.

Embodiments described herein can address some of these issues by providing user interface component configuration techniques for requests associated with items. In some embodiments, a pluggable component is generated for a user interface for processing resource requests. In this context and elsewhere herein, a pluggable component is intended to be broadly construed so as to encompass, for example, a component that can be provided or integrated into one or more applications for rendering information to a user interface.

Some embodiments can update one or more user interface components by dynamically generating a configuration tree using hierarchical request attributes and lifecycle information as described in further detail herein. Some embodiments are described in the context of dynamic requests, but it is important to note that other embodiments can be applied to any type of user interface involving dynamic user experiences.

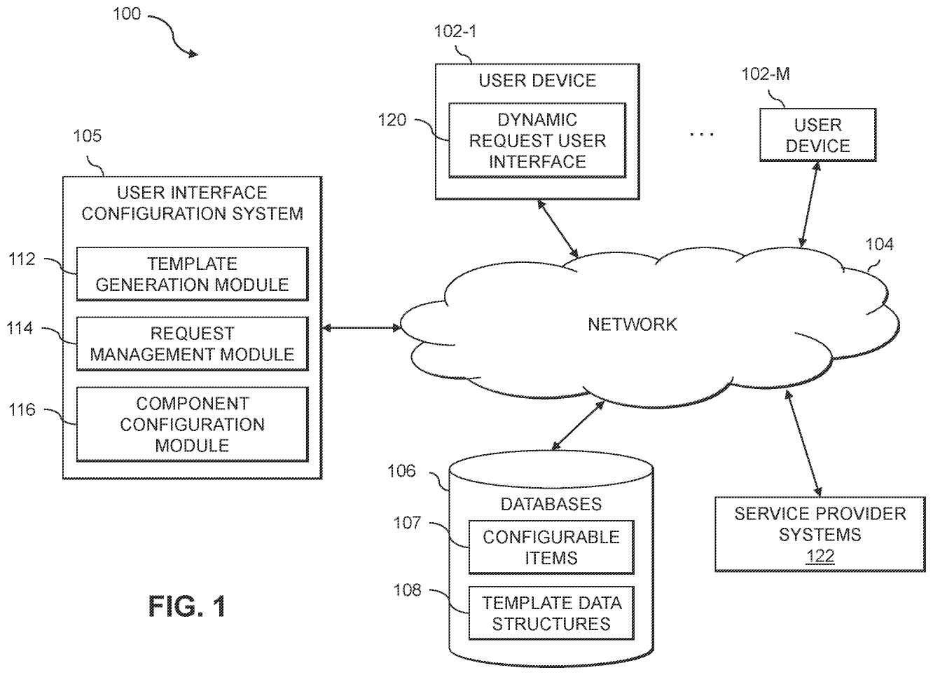

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a user interface configuration system 105 and one or more service provider systems 122.

The user device 102-1 comprises a dynamic request user interface 120 for configuring one or more user interface components based on one or more requests, as explained in more detail herein. It is to be appreciated that one or more of the other user devices 102 may also comprise respective dynamic request user interfaces 120.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the user interface configuration system 105 can have one or more databases 106 configured to store data pertaining to, for example, one or more configurable items 107 and/or one or more template data structures 108. In some embodiments, the template data structures 108 can comprise a tree data structure that comprises information related to request attributes and lifecycle information, for example.

An example database 106, such as depicted in the present embodiment, can be implemented using one or more storage systems associated with the user interface configuration system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the user interface configuration system 105 are one or more input-output devices, which illustratively comprise keyboards, displays or other types of input-output devices in any combination. Such input-output devices can be used, for example, to support one or more user interfaces to the user interface configuration system 105, as well as to support communication between user interface configuration system 105 and other related systems and devices not explicitly shown.

Additionally, the user interface configuration system 105 in the FIG. 1 embodiment is assumed to be implemented using at least one processing device. Each such processing device generally comprises at least one processor and an associated memory, and implements one or more functional modules for controlling certain features of the user interface configuration system 105.

More particularly, the user interface configuration system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the user interface configuration system 105 to communicate over the network 104 with the user devices 102, and illustratively comprises one or more conventional transceivers.

The user interface configuration system 105 further comprises a template generation module 112, a request management module 114, and a component configuration module 116.

Generally, the template generation module 112 typically encompasses functionality for consuming data related to attributes and rules for one or more products and/or one or more services, and constructing one or more data structures (e.g., one or more template data structures 108), which can be used to configure the dynamic request user interface 120, for example. In at least some embodiments, at least a portion of the rules can be manually created (e.g., by a system administrator), which then be systematically derived over time.

The request management module 114 includes functionality for managing information related to product and/or service offerings. In some embodiments, the information can include rules, events, and/or attributes for the product and/or the service offerings. In at least some embodiments, the information can be retrieved from one or more service provider systems 122. The service provider systems 122 can optionally be configured to provide at least some of the products and/or the services based on dynamic requests sent by the user devices (e.g., via the dynamic request user interface 120).

The request management module 114 can also manage information related to one or more of the configurable items 107 based on dynamic requests from one or more of the user devices 102 related to such offerings.

The component configuration module 116, in some embodiments, is configured to generate or update components of one or more user interfaces (e.g., the dynamic request user interface 120) based at least in part on the one or more data structures generated by the template generation module 112, as explained in more detail herein.

It is to be appreciated that this particular arrangement of elements 112, 114, and 116 illustrated in the user interface configuration system 105 of the FIG. 1 embodiment is presented by way of example only, and alternative arrangements can be used in other embodiments. For example, the functionality associated with the elements 112, 114, and 116 in other embodiments can be combined into a single module, or separated across a larger number of modules. As another example, multiple distinct processors can be used to implement different ones of the elements 112, 114, and 116 or portions thereof.

At least portions of elements 112, 114, and 116 may be implemented at least in part in the form of software that is stored in memory and executed by a processor.

It is to be understood that the particular set of elements shown in FIG. 1 for user interface configuration system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the user interface configuration system 105 and one or more of the databases 106 can be on and/or part of the same processing platform.

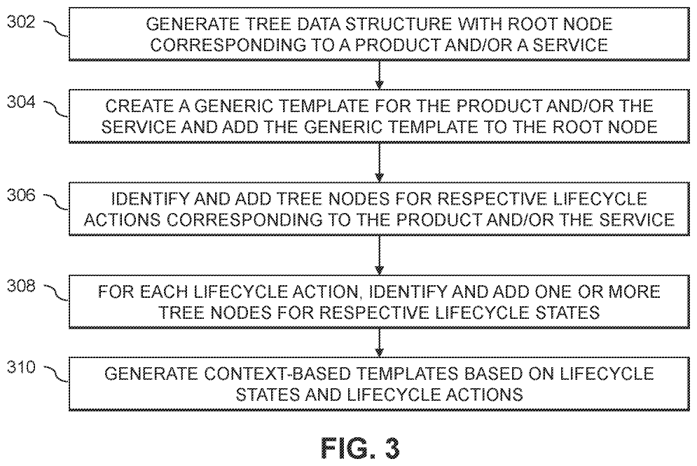

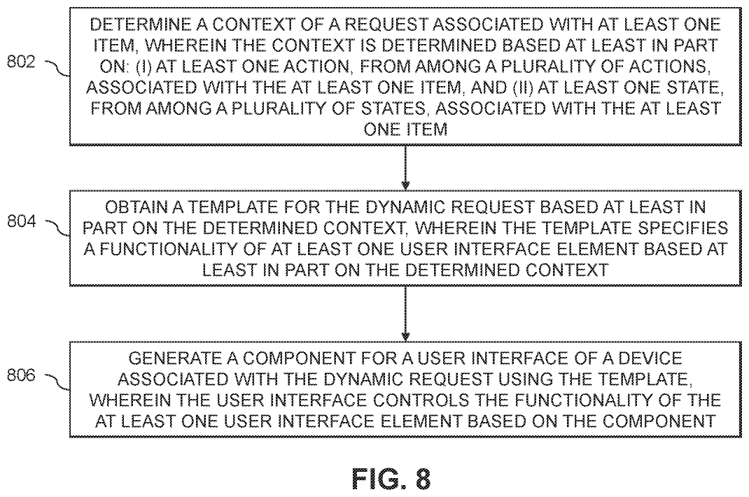

An exemplary process utilizing elements 112, 114, and 116 of an example user interface configuration system 105 in computer network 100 will be described in more detail with reference to, for example, the flow diagrams of FIGS. 3 and 8.

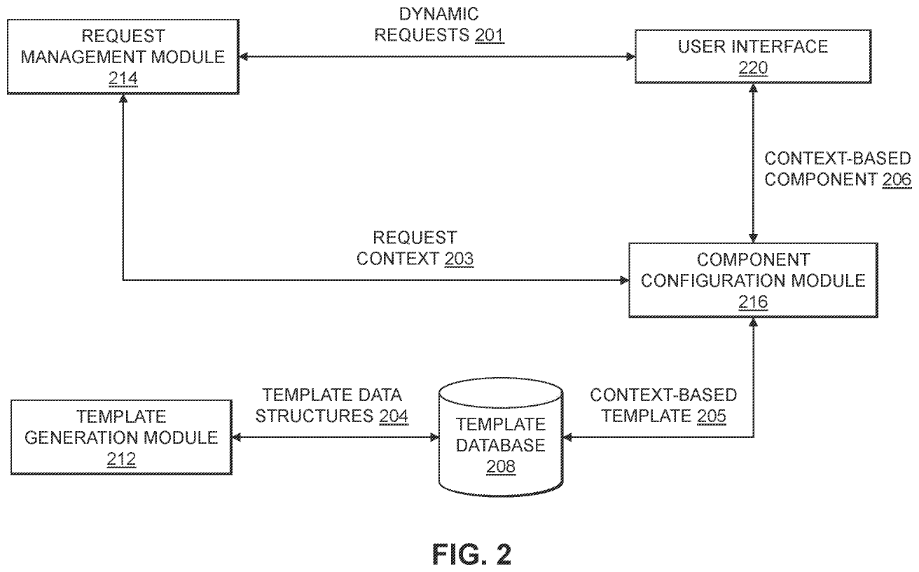

FIG. 2 shows an example of an architecture for configuring a user interface in an illustrative embodiment. In this example, the system architecture includes a template generation module 212, a request management module 214, a component configuration module 216, and a user interface 220 respectively corresponding to elements 112, 114, 116, and 120 in FIG. 1, for example.

The template generation module 212 obtains information related to product and/or service offerings (e.g., from the one or more service provider systems 122). The information may correspond to one or more of: names associated with the products and/or the services; one or more identifiers; one or more versions; one or more selection attributes; one or more lifecycle actions (also referred to as lifecycle events herein); and one or more lifecycle rules. The lifecycle rules can specify one or more user interface features that can be enabled and/or disabled based on the type of action, the type of offering, and/or one or more periods of time (e.g., within one day from a request to acquire a product and/or service, one day before the end of a term, one day after the end of a term). A non-limiting example of such a lifecycle rule can include: if a request to initiate a service occurred within twenty-fours, enable user interface element for canceling the service; otherwise, disable the user interface element for canceling the service.

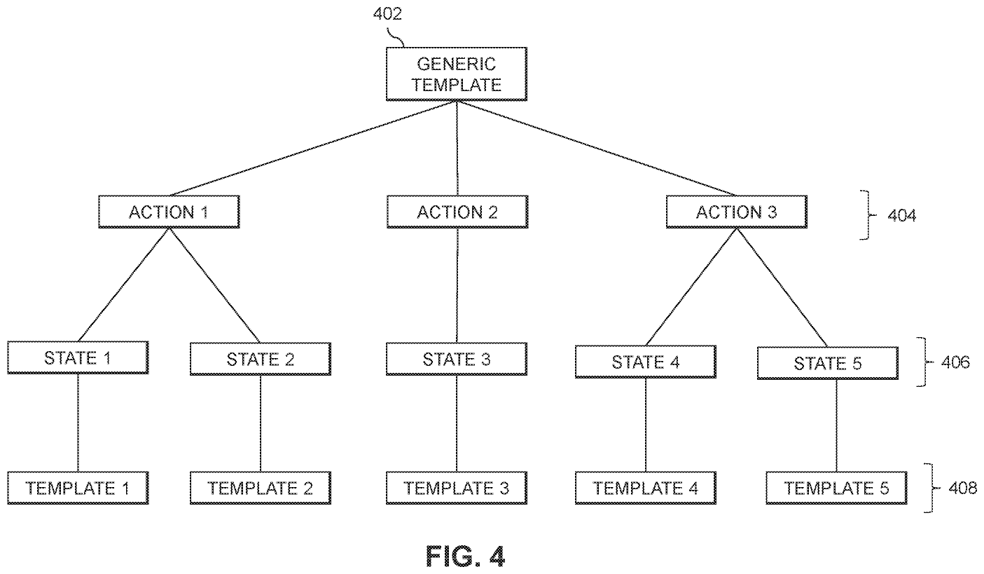

The template generation module 212 generates template data structures 204 based on the obtained information, and stores the template data structures 204 in a template database 208, for example. In some embodiments, the template data structures 204 are generated in the form of tree data structures, as explained in more detail in conjunction with FIGS. 3 and 4.

The user interface 220 generates one or more dynamic requests 201. For example, the dynamic requests 201 can be generated in response to one or more interactions of a user with a web application, for example. Such interactions can include, for example, selecting, modifying, and/or canceling one or more features related to one or more products and/or one or more services. As an example, a first one of the dynamic requests 201 can select features for configuring one or more products and/or services, and one or more subsequent ones of the dynamic requests 201 can be used to modify or cancel such selected features. The request management module 214 can maintain information related to the dynamic requests 201 in the form of at least one configurable item (e.g., one of the configurable items 107 in FIG. 1).

The request management module 214 can process the dynamic requests 201 to update the configurable item. For example, the request management module 214 can update the configurable item with information corresponding to one or more identifiers (e.g., to identify the configurable item, products, and/or services), one or more selection attributes (e.g., features related to the products and/or services), lifecycle states (e.g., corresponding to one or more start dates and one or more end dates), and one or more lifecycle rules.

In some embodiments, the user interface 220 calls the component configuration module 216 to generate a context-based component 206 for at least a portion of the user interface 220. In some embodiments, the call can include identifier information, version information, and/or at least one lifecycle action. In response, the component configuration module 216 can obtain a request context 203 from the request management module 214. For example, the identifier information, version information, and/or the lifecycle action in the call can be used to derive the request context 203 from the corresponding configurable item.

The component configuration module 216 identifies a current state of the request based on one or more rules applicable to the one or more lifecycle actions and the request. The component configuration module 216 searches the template database 208 to obtain a context-based template 205 that corresponds to the request context 203. For example, the component configuration module 216 can identify one of the template data structures 204, and then search the identified template data structure 204 using the request context 203 (e.g., based on the lifecycle action and lifecycle state) to obtain the context-based template 205 in the identified template data structure 204. The component configuration module 216 then builds the context-based component 206 by filling the context-based template 205 with the relevant details from the request context 203, as explained in more detail elsewhere herein. Accordingly, the context-based component 206 can be dynamically generated at runtime to efficiently control features (e.g., enabling or disabling features) in the user interface 220.

FIG. 3 shows a flow diagram for generating template data structures in an illustrative embodiment. It is to be understood that this particular process is only an example, and additional or alternative processes can be carried out in other embodiments. In this embodiment, the process includes steps 302 to 310. These steps are assumed to be performed by the template generation module 212, for example.

Step 302 includes generating a tree data structure with a root node related to a product and/or a service. The root node can include information related to at least one of a request identifier and a request version, for example.

Step 304 includes creating a generic template for the product and/or the service. In some embodiments, the generic template is added to the root node in the tree data structure. As an example, the generic template can be created by extracting selection attributes related to a sequence of lifecycle actions. In some embodiments, the generic template can be developed (e.g., using HTML (HyperText Markup Language), JavaScript, and/or CSS (cascading style sheets)), such that the template produces a generic view (e.g., an HTML page). The generic template also includes various user interface components that can be dynamically disabled or enabled depending on the context.

Step 306 includes identifying and adding tree nodes for respective lifecycle actions corresponding to the product and/or the service. The lifecycle actions can correspond to dynamic requests related to acquiring the product and/or the service, as well as dynamic requests for selecting, modifying, and/or canceling one or more features (including expanding, upgrading, and/or renewing such features, as non-limiting examples).

Step 308 includes, for each lifecycle action, identifying and adding one or more tree nodes for respective lifecycle states. The lifecycle states can be identified based on the lifecycle rules extracted by the template generation module 212, for example.

Step 310 includes generating context-based templates based on the lifecycle states and the lifecycle actions. For example, step 310 can generate the context-based templates by determining whether to allow or restrict specific features to be configured for each of the lifecycle states and actions.

FIG. 4 shows an example of a template data structure in an illustrative embodiment. The template data structure shown in FIG. 4 corresponds to an offer configuration for a product or a service, for example. The template data structure includes a generic template 402 (e.g., generated at step 304 in the FIG. 3 process), a set of action nodes 404, a set of state nodes 406, and a set of template nodes 408. The set of action nodes 404 generally corresponds to lifecycle actions (e.g., action 1 can correspond to an expand action, action 2 can correspond to an upgrade action, and action 3 can correspond to a renewal action). The set of state nodes 406 corresponds to different lifecycle states. For instance, states 1 and 2 can correspond to different time periods relative to a start date and/or an end date. The set of template nodes 408 corresponds to context-based templates (such as the context-based template 205). The template data structure shown in FIG. 4 can be searched (for example, by the component configuration module 216) to identify the template to be used for a particular lifecycle action and state.

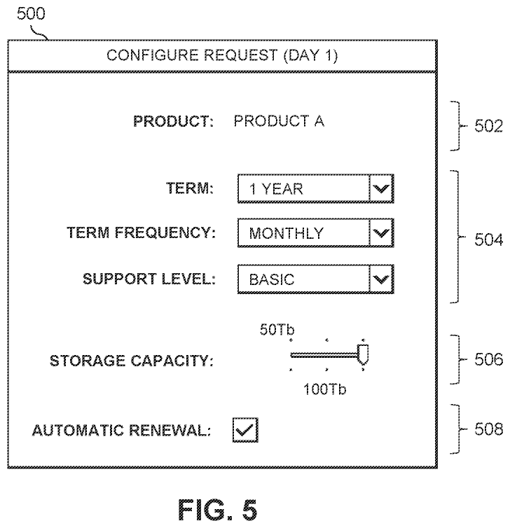

FIG. 5 shows an example of a user interface 500 configured at a first state in an illustrative embodiment. It is assumed that the user interface shown in FIG. 5 corresponds to an initial configuration (e.g., a Day-1 action). The user interface 500 identifies a product (Product A) in section 502. The user interface 500 also includes three drop-down elements in section 504 for setting a term, a term frequency, and a support level; a slider element in section 506 for selecting a storage capacity; and a checkbox element in section 508 for selectively enabling an automatic renewal option. It is noted that the user interface 500, generated at least in part using one or more context-based templates based on one or more lifecycle states and one or more lifecycle actions associated with the first state (e.g., an initial configuration of the product), permits adjustment of the elements shown in sections 504, 506, and 508, but restricts the adjustment of the product name in section 502.

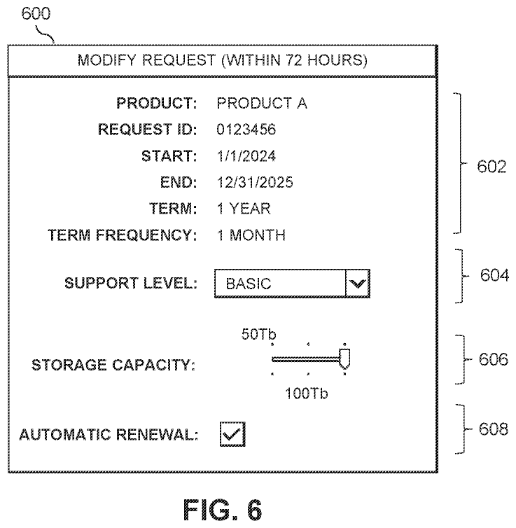

FIG. 6 shows another example of a user interface 600 configured at a second state in an illustrative embodiment. The example shown in FIG. 6 assumes that Product A has been configured (e.g., using the user interface 500) and that the user has requested to modify Product A within a first time period following the initial configuration (e.g., within 72 hours). Accordingly, the user interface 600 has been updated to display additional information. For example, section 602 of the user interface 600 includes a request identifier, a start date, an end date, a term, and a term frequency that were established as part of the Day-1 action of FIG. 5. It is also noted that the user interface 600, generated at least in part using one or more context-based templates based on one or more lifecycle states and one or more lifecycle actions associated with the second state (e.g., a modification of the initial configuration of the product within a permitted timeframe), restricts the information shown in section 602 from being changed. Other parameters, such as the support level parameter in section 604, storage capacity parameter in section 606, and automatic renewal parameter in section 608, that may be modified within the permitted timeframe, can be adjusted.

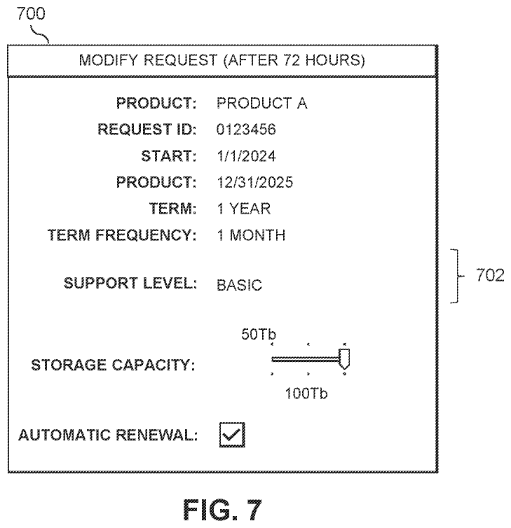

FIG. 7 shows an example of a user interface 700 configured at a third state in an illustrative embodiment. In the example shown in FIG. 7, it is assumed that the user has requested to modify the request after the first time period following the initial configuration (e.g., after 72 hours). The only difference between the user interface 600 and the user interface 700, generated at least in part using one or more context-based templates based on one or more lifecycle states and one or more lifecycle actions associated with the third state (e.g., a modification of the initial configuration of the product outside of a permitted timeframe), is that the support level parameter in section 702 can no longer be adjusted.

It is to be appreciated that user interfaces 500, 600, and 700 are non-limiting examples of user interfaces that are configured for three different contexts. It is to be appreciated that in other embodiments additional and/or different user interfaces can be configured depending on, for example, the number of states or events and/or the number or types of events being implemented.

FIG. 8 is a flow diagram of a process for configuring user interface components for requests associated with items in an illustrative embodiment. It is to be understood that this particular process is only an example, and additional or alternative processes can be carried out in other embodiments.

In this embodiment, the process includes steps 802 through 806. These steps are assumed to be performed by the user interface configuration system 105 utilizing one or more of its elements 112, 114, and 116.

Step 802 includes determining a context of a request associated with at least one item, wherein the context is determined based at least in part on: (i) at least one action, from among a plurality of actions, associated with the at least one item, and (ii) at least one state, from among a plurality of states, associated with the at least one item.

Step 804 includes obtaining a template for the request based at least in part on the determined context, wherein the template specifies a functionality of at least one user interface element based at least in part on the determined context.

Step 806 includes generating a component for a user interface of a device associated with the request using the template, wherein the user interface controls the functionality of the at least one user interface element based on the component.

The process can further include a step of generating a tree data structure comprising a first set of nodes corresponding to respective ones of the plurality of actions, a second set of nodes corresponding to respective ones of the plurality of states, and a third set of nodes, where a given node in the third set comprises a given template corresponding to a given one of the plurality of states and a given one of the plurality of actions. The template for the request may be obtained from the tree data structure based on the determined context. At least a portion of the plurality of states may correspond to respective timeframes related to a configuration of at least one of a subscription and a product. The plurality of actions may include at least one of: creating a subscription, modifying a subscription, and canceling a subscription. The at least one user interface element may be configured to control an adjustment of at least one feature corresponding to a configuration of at least one of a subscription and a product. The functionality of the at least one user interface element may be controlled by restricting the adjustment of the at least one feature. The functionality of the at least one user interface element may be controlled by enabling the adjustment of the at least one feature.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to enable customizing user interface components based on contextual information related to lifecycle events and lifecycle states. Additionally, at least some embodiments can dynamically generate a user interface component that restricts or allows certain features based on a current context. These and other embodiments can effectively reduce the size and complexity of user interface configuration components, and can also improve loading and rendering times at runtime relative to conventional approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

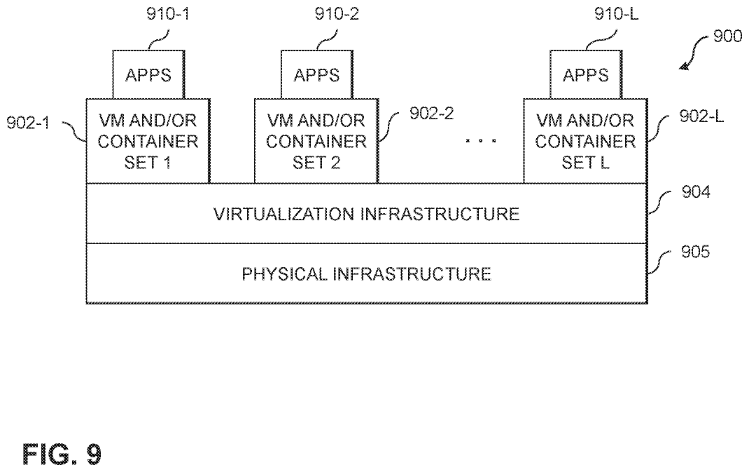

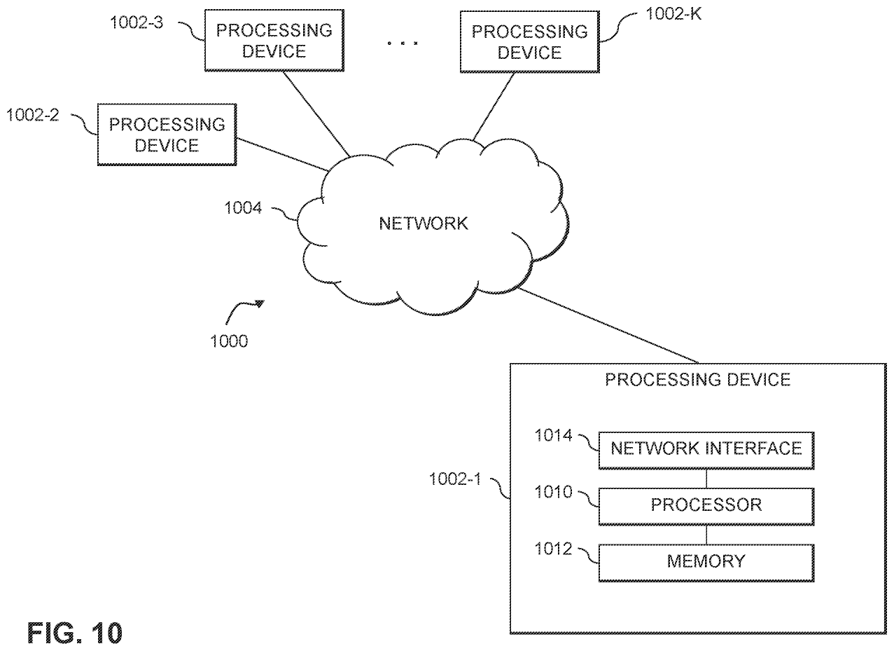

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a microcontroller, an ASIC, an FPGA or other type of processing circuitry, as well as portions or combinations of such circuitry elements.

The memory 1012 comprises RAM, ROM or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
determining a context of a request associated with at least one item, wherein the context is determined based at least in part on: (i) at least one action, from among a plurality of actions, associated with the at least one item, and (ii) at least one state, from among a plurality of states, associated with the at least one item;
obtaining a template for the request based at least in part on the determined context, wherein the template specifies a functionality of at least one user interface element based at least in part on the determined context; and
generating a component for a user interface of a device associated with the request using the template, wherein the user interface controls the functionality of the at least one user interface element based on the component;
wherein the method is performed by at least one processing device comprising a processor coupled to a memory.

2. The computer-implemented method of claim 1, further comprising:
generating a tree data structure comprising a first set of nodes corresponding to respective ones of the plurality of actions, a second set of nodes corresponding to respective ones of the plurality of states, and a third set of nodes, wherein a given node in the third set comprises a given template corresponding to a given one of the plurality of states and a given one of the plurality of actions.

3. The computer-implemented method of claim 2, wherein the template for the request is obtained from the tree data structure based on the determined context.

4. The computer-implemented method of claim 1, wherein at least a portion of the plurality of states corresponds to respective timeframes related to a configuration of at least one of a subscription and a product.

5. The computer-implemented method of claim 1, wherein the plurality of actions comprises at least one of: creating a subscription, modifying a subscription, and canceling a subscription.

6. The computer-implemented method of claim 1, wherein the at least one user interface element is configured to control an adjustment of at least one feature corresponding to a configuration of at least one of a subscription and a product.

7. The computer-implemented method of claim 6, wherein the functionality of the at least one user interface element is controlled by restricting the adjustment of the at least one feature.

8. The computer-implemented method of claim 6, wherein the functionality of the at least one user interface element is controlled by enabling the adjustment of the at least one feature.

9. A non-transitory processor-readable storage medium having stored therein program code of one or more software programs, wherein the program code when executed by at least one processing device causes the at least one processing device:
to determine a context of a request associated with at least one item, wherein the context is determined based at least in part on: (i) at least one action, from among a plurality of actions, associated with the at least one item, and (ii) at least one state, from among a plurality of states, associated with the at least one item;
to obtain a template for the request based at least in part on the determined context, wherein the template specifies a functionality of at least one user interface element based at least in part on the determined context; and
to generate a component for a user interface of a device associated with the request using the template, wherein the user interface controls the functionality of the at least one user interface element based on the component.

10. The non-transitory processor-readable storage medium of claim 9, wherein the program code when executed by the at least one processing device further causes the at least one processing device:
to generate a tree data structure comprising a first set of nodes corresponding to respective ones of the plurality of actions, a second set of nodes corresponding to respective ones of the plurality of states, and a third set of nodes, wherein a given node in the third set comprises a given template corresponding to a given one of the plurality of states and a given one of the plurality of actions.

11. The non-transitory processor-readable storage medium of claim 10, wherein the template for the request is obtained from the tree data structure based on the determined context.

12. The non-transitory processor-readable storage medium of claim 9, wherein at least a portion of the plurality of states corresponds to respective timeframes related to a configuration of at least one of a subscription and a product.

13. The non-transitory processor-readable storage medium of claim 9, wherein the plurality of actions comprises at least one of: creating a subscription, modifying a subscription, and canceling a subscription.

14. The non-transitory processor-readable storage medium of claim 9, wherein the at least one user interface element is configured to control an adjustment of at least one feature corresponding to a configuration of at least one of a subscription and a product.

15. The non-transitory processor-readable storage medium of claim 14, wherein the functionality of the at least one user interface element is controlled by restricting the adjustment of the at least one feature.

16. An apparatus comprising:
at least one processing device comprising a processor coupled to a memory;
the at least one processing device being configured:
to determine a context of a request associated with at least one item, wherein the context is determined based at least in part on: (i) at least one action, from among a plurality of actions, associated with the at least one item, and (ii) at least one state, from among a plurality of states, associated with the at least one item;
to obtain a template for the request based at least in part on the determined context, wherein the template specifies a functionality of at least one user interface element based at least in part on the determined context; and
to generate a component for a user interface of a device associated with the request using the template, wherein the user interface controls the functionality of the at least one user interface element based on the component.

17. The apparatus of claim 16, wherein the at least one processing device is further configured:
to generate a tree data structure comprising a first set of nodes corresponding to respective ones of the plurality of actions, a second set of nodes corresponding to respective ones of the plurality of states, and a third set of nodes, wherein a given node in the third set comprises a given template corresponding to a given one of the plurality of states and a given one of the plurality of actions.

18. The apparatus of claim 17, wherein the template for the request is obtained from the tree data structure based on the determined context.

19. The apparatus of claim 16, wherein at least a portion of the plurality of states corresponds to respective timeframes related to a configuration of at least one of a subscription and a product.

20. The apparatus of claim 16, wherein the plurality of actions comprises at least one of: creating a subscription, modifying a subscription, and canceling a subscription.
